(19) United States
(12) Patent Application Publication
(10) Pub. No.: US 2019/0047641 A1
(43) Pub. Date: Feb. 14, 2019

(54) ACTIVE AERODYNAMIC BODY PANEL FOR AN AUTOMOTIVE VEHICLE

(71) Applicant: GM GLOBAL TECHNOLOGY OPERATIONS LLC, Detroit, MI (US)

(72) Inventors: Mark R. Claywell, Birmingham, MI (US); Maqsood Rizwan Ali Khan, Rochester Hills, MI (US); Marsella L. White, Howell, MI (US)

(21) Appl. No.: 15/671,435

(22) Filed: Aug. 8, 2017

(51) Int. Cl. B62D 35/00; B62D 37/02; B60W 10/00

(52) U.S. Cl. CPC B62D 35/008; B62D 37/02; B60W 2710/20; B60W 2520/14; B60W 2520/10; B60W 10/00

(57) ABSTRACT

An automotive vehicle includes a body with a central plane extending vertically along a longitudinal center of the body, with first and second sides on opposing sides of the central plane. The vehicle additionally includes a first movable member coupled to the first side. The first movable member has a first stowed position and a first deployed position. In the first deployed position the first movable member induces a first pressure differential between the first side and the second side. The vehicle also includes a first actuator configured to move the first movable member between the first stowed position and the first deployed position. The vehicle further includes a controller configured to, in response to satisfaction of a first operating condition, control the first actuator to move the first movable member from the first stowed position to the first deployed position.

### TECHNICAL FIELD

The present disclosure relates to automotive vehicles, and more particularly to aerodynamic features of automotive vehicles.

### INTRODUCTION

For performance automotive vehicles, aerodynamic characteristics at high vehicle speeds are very important. Performance vehicles are generally designed for a desired dynamic balance among four vehicle wheels. This balance affects various vehicle handling characteristics, including steering. However, known systems and methods for improving vehicle handling generally increase the aerodynamic load on a vehicle, which may impact ride height of the vehicle, in turn necessitating suspension changes such as stiffer springs. Such changes may impact other vehicle handling characteristics in an undesired manner.

### SUMMARY

An automotive vehicle according to the present disclosure includes a body. The body has a fore portion, an aft portion, a longitudinal center extending from the fore portion to the aft portion, and a central plane extending vertically along the longitudinal center, with a first side and a second side on opposing sides of the central plane. The vehicle additionally includes a first movable member coupled to the first side. The first movable member has a first stowed position and a first deployed position. In the first deployed position the first movable member induces a first pressure differential between the first side and the second side. The vehicle also includes a first actuator configured to move the first movable member between the first stowed position and the first deployed position. The vehicle further includes a controller configured to, in response to satisfaction of a first operating condition, control the first actuator to move the first movable member from the first stowed position to the first deployed position.

In an exemplary embodiment, the automotive vehicle additionally includes a steering wheel having a nominal position, wherein the first operating condition includes a difference between a current steering wheel position and the nominal position exceeding a predefined threshold.

In an exemplary embodiment, the first operating condition includes a current vehicle velocity exceeding a predefined threshold.

In an exemplary embodiment, the first operating condition includes a current vehicle yaw rate exceeding a predefined threshold.

In an exemplary embodiment, the vehicle additionally includes a second movable member coupled to the second side. The second movable member has a second stowed position and a second deployed position. In the second deployed position the second movable member induces a second pressure differential between the first side and the second side. The second pressure differential is oriented in a direction opposite the first pressure differential. In such embodiments, the vehicle also includes a second actuator configured to move the second movable member between the second stowed position and the second deployed position. In such embodiments, the controller is further configured to, in response to satisfaction of a second operating condition, control the second actuator to move the second movable member from the second stowed position to the first deployed position. The controller may be configured to, in response to satisfaction of the first operating condition, control the second actuator to maintain the second movable member in the second stowed position, and to, in response to satisfaction of the second operating condition, control the first actuator to maintain the first movable member in the first stowed position. The controller may be further configured to, in response to a braking request exceeding a threshold, control the first actuator to move the first movable member from the first stowed position to the first deployed position and control the second actuator to move the second movable member from the second stowed position to the first deployed position.

In an exemplary embodiment, the first movable member includes a generally planar panel. In the stowed position the generally planar panel abuts the first side, and in the deployed position the generally planar panel is projected from the first side.

A method of controlling a vehicle according to the present disclosure includes providing a vehicle with a body having a first side and a second side, providing a first movable member, providing a first actuator, and providing a controller. The first movable member is coupled to the first side and has a first stowed position and a first deployed position. In the first deployed position the first movable member induces a first pressure differential between the first side and the second side. The first actuator is configured to move the first movable member between the first stowed position and the first deployed position. The controller is in communication with the first actuator. The method also includes, in response to satisfaction of a first operating condition with the vehicle in motion, controlling the first actuator, via the controller, to move the first movable member from the first stowed position to the first deployed position.

Embodiments according to the present disclosure provide a number of advantages. For example, the present disclosure provides a system and method for improved turning and braking of an automotive vehicle via body-acting aerodynamic forces.

The above and other advantages and features of the present disclosure will be apparent from the following detailed description of the preferred embodiments when taken in connection with the accompanying drawings.

### BRIEF DESCRIPTION OF THE DRAWINGS

FIG. 1 is a top view of an automotive vehicle according to an embodiment of the present disclosure;

FIG. 2 is a front view of an automotive vehicle according to an embodiment of the present disclosure;

FIG. 3 is a side view of an automotive vehicle according to an embodiment of the present disclosure; and

FIG. 4 is a flowchart representation of a method of controlling an automotive vehicle according to an embodiment of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but are merely representative. The various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desirable for particular applications or implementations.

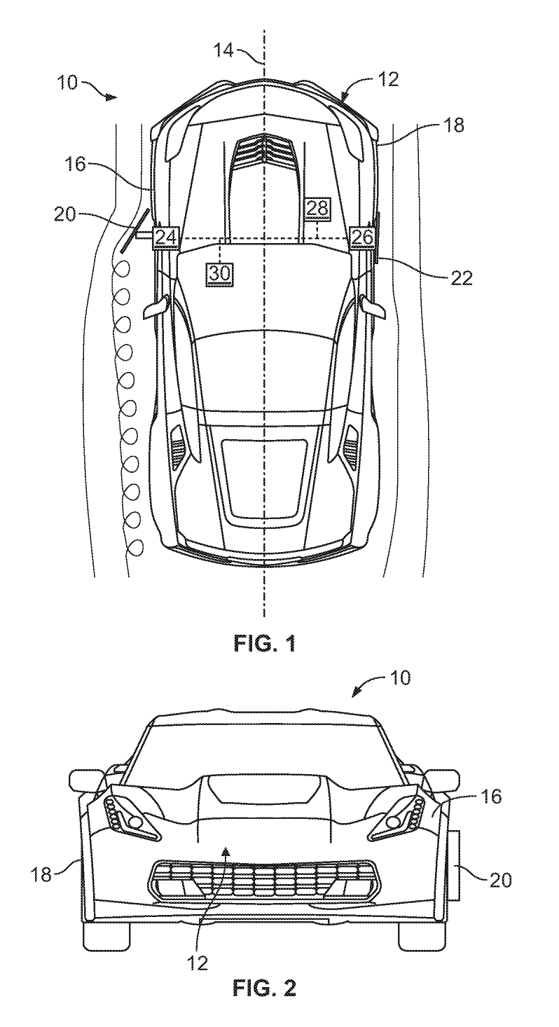

Referring now to FIGS. 1 and 2, an automotive vehicle 10 according to an embodiment of the present disclosure is illustrated. The vehicle 10 has a body 12 with a central longitudinal axis 14. A vertical plane passing through the longitudinal axis 14 separates the body 12 into a first side 16 and a second side 18. In the illustrated embodiment the first side 16 corresponds to a driver side of the vehicle 10 and the second side 18 corresponds to a passenger side of the vehicle 10.

A first movable member 20 is provided on the first side 16. In the illustrated embodiment, the first movable member 20 is disposed on a side body panel of the vehicle 10, i.e. not on a hood or roof panel of the vehicle. The first movable member 20 has a stowed position and a deployed position. In the illustrated embodiment, in the stowed position, the first movable member 20 is retained generally flush with the first side 16. In the deployed position, the first movable member 20 is projected away from the first side 16. In FIG. 1, the first movable member 20 is illustrated in the deployed position. The first movable member 20 may include a generally planar panel, a contoured airfoil, or other appropriate members for deflecting a fluid as discussed below. However, in other embodiments, the stowed position and the deployed position may refer to any two arbitrary positions of a movable member for inducing a pressure differential as discussed below.

A second movable member 22 is provided on the second side 18. The second movable member 22 likewise has a stowed position and a deployed position, generally as discussed above with respect to the first movable member 20. In FIG. 1, the second movable member 22 is illustrated in the stowed position.

A first actuator 24 is associated with the first movable member 20. The first actuator 24 is configured to drive the first movable member 20 between the stowed position and the deployed position. The first actuator 24 may include, for example, a linear actuator coupled to the first movable member 20.

A second actuator 26 is associated with the second movable member 22. The second actuator 26 is configured to drive the second movable member 22 between the stowed position and the deployed position. The second actuator 26 may include, for example, a second linear actuator coupled to the second movable member 22.

The first actuator 24 and the second actuator 26 are under the control of a controller 28. The controller 28 is provided with programming to command the first actuator 24 and the second actuator 26 to move the first movable member 20 and the second movable member 22, respectively, between the stowed and deployed positions in response to one or more criteria being satisfied, as will be discussed in further detail below.

While depicted as a single computing unit, the controller 28 may include multiple controllers collectively referred to as a “controller.” The controller 28 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller in controlling the engine or vehicle.

As illustrated by the streaklines about the body 12, when the first movable member 20 is in the deployed position, fluid passing about the body 12 forms a turbulent region proximate the first side 16 aftward of the first movable member 20. When the second movable member 22 is in the stowed position, fluid flow proximate the second side 18 is uninterrupted. A pressure differential may thereby be induced between the first side 16 and the second side 18. The pressure differential imposes a lateral force on the body 12.

Notably, the lateral force generated as a result of deployment of the first movable member 20 is independent of any downforce effects through vehicle tires. Advantageously, the lateral force may thereby be generated without necessitating changes to vehicle springs.

In addition, the vehicle 10 is provided with at least one sensor 30 in communication with the controller 28. In an exemplary embodiment, the at least one sensor 30 includes a steering angle sensor configured to produce a signal indicative of a steering wheel position. The at least one sensor 30 may also include a brake sensor configured to produce a signal indicative of a brake pedal position. The sensor 30 may also include a geolocation sensor such as a GPS receiver, an optical camera, an ultrasonic sensor, a RADAR or LiDAR system, other sensor, or any combination of the above sensors.

In the embodiment illustrated in FIG. 1, the first movable member 20 and second movable member 22 are arranged aft of front wheels of the vehicle 10, and include members configured to pivot and project away from the body 12 of the vehicle 10. However, in other embodiments within the scope of the present invention, other types of movable members may be implemented. As an example, the first movable member and second movable member may comprise deformable panels on the first side and second side, respectively. In such embodiments, first and second actuators may be configured to bulge the deformable panels away from the body and thereby accelerate air flow on a given side of the body and, in turn, induce a pressure differential between the first and second sides. Furthermore, in other embodiments within the scope of the present invention, movable members may be disposed in other locations on the first and second sides of the vehicle body. While the benefits may be increased by disposing the movable member in locations forward of the rear wheels of the vehicle, the movable members may be disposed in any appropriate location on the first and second sides.

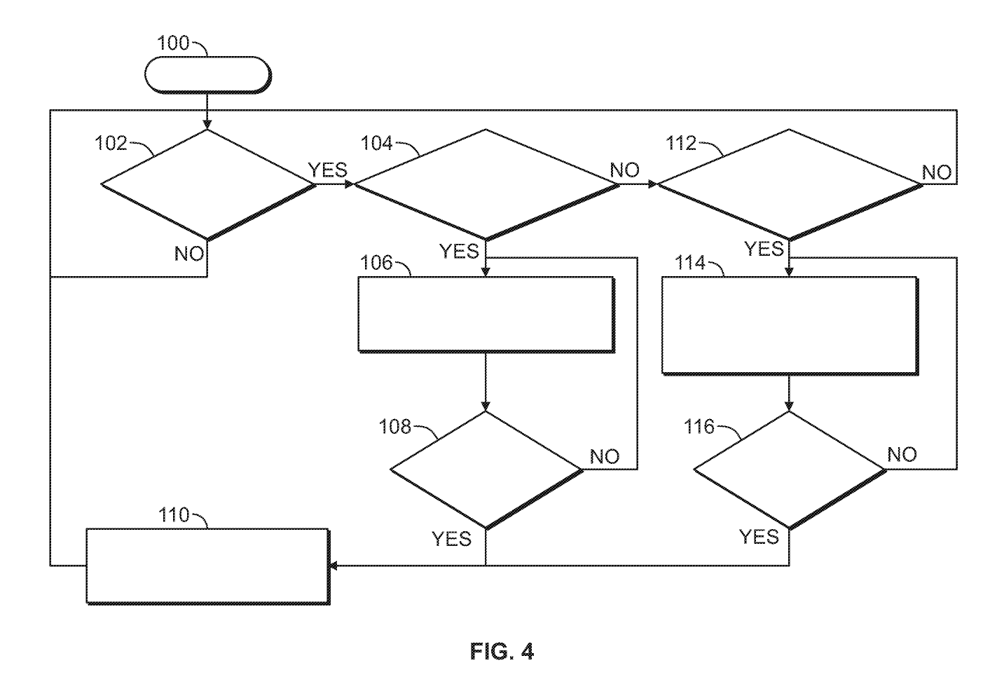

In an exemplary embodiment, the first movable member 20 and second movable member 22 may be deployed independently or together. As an example, one respective movable member may be deployed to provide additional lateral force in response to a turning request. As another example, both the first movable member 20 and second movable member 22 may be deployed together to increase drag on both the first side 16 and second side 18 in response to a braking request. An exemplary control schema will be discussed below with Respect to FIG. 4.

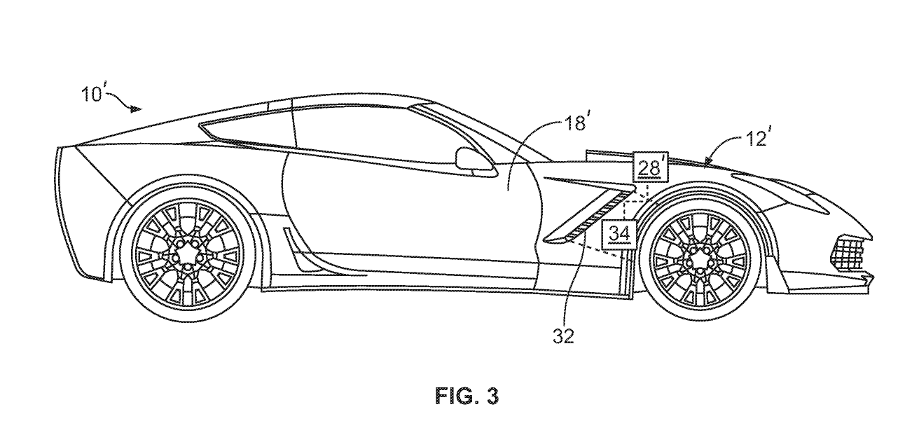

Referring now to FIG. 3, an alternative embodiment according to the present disclosure is illustrated. A vehicle 10′ has a body 12′ with a side 18′. A vent outlet 32 is provided on the side 18′. The vent outlet 32 is configured to receive a fluid, such as air, from a vent and direct the fluid to the exterior of the vehicle along the side 18′. The vent directs fluid from a heat source to the vent outlet 32. In the illustrated embodiment the heat source includes a vehicle brake system and the duct has an inlet proximate the vehicle brake system to receive heated air; however, in other embodiments the heat source may include the vehicle engine. An active shutter system 34 comprising a plurality of movable shutter members is disposed upstream of the vent outlet 32 and is configured to control fluid flow rate through the vent outlet 32. The shutter system 34 is under the control of a controller 28′.

In such an embodiment, the controller 28′ may control the shutter system 34 to change fluid flow through the vent outlet 32, and thereby create a thermal difference between opposing sides of the vehicle. The thermal difference may in turn create a fluid density difference resulting in a side force similar to that discussed above.

Referring now to FIG. 4, a method of controlling a vehicle according to the present disclosure is illustrated in flowchart form. The method may be performed by a controller, e.g. configured generally as the controller 28 illustrated in FIG. 1. The method begins at block 100.

A determination is made of whether a current vehicle speed exceeds a predefined threshold, as illustrated at block 102. In an exemplary embodiment the predefined threshold is 60 MPH, though other values may, of course, be used. The threshold is selected to avoid unnecessary actuation of movable members at low speeds where little aerodynamic benefit would be obtained.

If the determination of operation 102 is negative, control remains at operation 102. The algorithm therefore does not proceed unless and until vehicle speed exceeds the threshold.

If the determination of operation 102 is positive, control proceeds to operation 104. A determination is made of whether a braking request exceeding a predefined threshold is received, as illustrated at operation 104. As discussed above, the braking request may be received via a signal from a braking sensor configured to monitor a brake pedal position. However, in vehicles having autonomous driving systems, the braking request may be generated by the autonomous driving system rather than by a human operator via a brake pedal. In an exemplary embodiment, the braking threshold corresponds to heavy braking, though other values may be used.

If the determination of operation 104 is positive, then actuators are controlled to deploy the first movable member and the second movable member, as illustrated at block 106. As discussed above, turbulent flow induced by the movable members may thereby increase drag and support deceleration of the vehicle.

A determination is then made of whether the braking request falls below the threshold, as illustrated at block 108.

If the determination of operation 108 is negative, then control returns to block 106 and the movable members are maintained in the deployed positions. The movable members are thereby maintained in the deployed position until the braking request falls below the threshold.

If the determination of operation 108 is positive, then the actuators are controlled to move the first movable member and second movable member to the stowed position, as illustrated at block 110. Control then returns to operation 102.

Returning to operation 104, if the determination is negative, then control proceeds to operation 112.

A determination is made of whether a steering request exceeding a predefined threshold is received, as illustrated at operation 112. As discussed above, the steering request may be received via a signal from a steering sensor configured to monitor a steering wheel position. However, in other embodiments other steering requests may be used. For example, in vehicles having autonomous driving systems, the steering request may be generated by the autonomous driving system rather than by a human operator via a steering wheel.

If the determination of operation 112 is negative, control returns to operation 102. The algorithm thereby does not proceed unless and until a braking request or a steering request is received.

If the determination of operation 112 is positive, then an actuator is controlled to deploy one movable member while maintaining the other in a stowed position, as illustrated at block 114. The deployed movable member may induce turbulence and thereby generate a side force to support turning the vehicle, as discussed above with respect to FIG. 1.

A determination is then made of whether the steering request falls below the threshold, as illustrated at operation 116.

If the determination of operation 116 is negative, then control returns to block 114 and the first and second movable members are maintained in the deployed and stowed positions, respectively. The movable members are thereby maintained in their respective positions until the steering request falls below the threshold.

If the determination of operation 116 is positive, then the actuators are controlled to move the first movable member and second movable member to the stowed position, as illustrated at block 110. Control then returns to operation 102.

As may be seen, the present disclosure provides a system and method for improved turning and braking of an automotive vehicle.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. An automotive vehicle comprising:
a body having a fore portion, an aft portion, a longitudinal center extending from the fore portion to the aft portion, and a central plane extending vertically along the longitudinal center, with a first side and a second side on opposing sides of the central plane;
a first movable member coupled to the first side, the first movable member having a first stowed position and a first deployed position, wherein in the first deployed position the first movable member induces a first pressure differential between the first side and the second side;
a first actuator configured to move the first movable member between the first stowed position and the first deployed position; and
a controller configured to, in response to satisfaction of a first operating condition, control the first actuator to move the first movable member from the first stowed position to the first deployed position.

2. The automotive vehicle of claim 1, further comprising a steering wheel having a nominal position, wherein the first operating condition includes a difference between a current steering wheel position and the nominal position exceeding a predefined threshold.

3. The automotive vehicle of claim 1, wherein the first operating condition includes a current vehicle velocity exceeding a predefined threshold.

4. The automotive vehicle of claim 1, wherein the first operating condition includes a current vehicle yaw rate exceeding a predefined threshold.

5. The automotive vehicle of claim 1, further comprising a second movable member coupled to the second side, the second movable member having a second stowed position and a second deployed position, wherein in the second deployed position the second movable member induces a second pressure differential between the first side and the second side, the second pressure differential being oriented in a direction opposite the first pressure differential; and
a second actuator configured to move the second movable member between the second stowed position and the second deployed position;
wherein the controller is further configured to, in response to satisfaction of a second operating condition, control the second actuator to move the second movable member from the second stowed position to the first deployed position.

6. The automotive vehicle of claim 5, wherein the controller is configured to, in response to satisfaction of the first operating condition, control the second actuator to maintain the second movable member in the second stowed position, and to, in response to satisfaction of the second operating condition, control the first actuator to maintain the first movable member in the first stowed position.

7. The automotive vehicle of claim 5, wherein the controller is further configured to, in response to a braking request exceeding a threshold, control the first actuator to move the first movable member from the first stowed position to the first deployed position and control the second actuator to move the second movable member from the second stowed position to the first deployed position.

8. The automotive vehicle of claim 1, wherein the first movable member includes a generally planar panel, in the stowed position the generally planar panel abuts the first side, and in the deployed position the generally planar panel is projected from the first side.

9. The automotive vehicle of claim 1, further comprising a thermal source and a duct, the duct having an inlet proximate the source and an outlet on the first side, wherein the first movable member is disposed in the duct.

10. A method of controlling a vehicle, comprising:
providing a vehicle with a body having a first side and a second side;
providing a first movable member coupled to the first side, the first movable member having a first stowed position and a first deployed position, wherein in the first deployed position the first movable member induces a first pressure differential between the first side and the second side;
providing a first actuator configured to move the first movable member between the first stowed position and the first deployed position;
providing a controller in communication with the first actuator; and
in response to satisfaction of a first operating condition with the vehicle in motion, controlling the first actuator, via the controller, to move the first movable member from the first stowed position to the first deployed position.

11. The method of claim 10, wherein the first operating condition includes a difference between a current steering wheel position and the nominal position exceeding a predefined threshold.

12. The method of claim 10, wherein the first operating condition includes a current vehicle velocity exceeding a predefined threshold.

13. The method of claim 10, wherein the first operating condition includes a current vehicle yaw rate exceeding a predefined threshold.

14. The method of claim 10, further comprising providing a second movable member coupled to the second side, the second movable member having a second stowed position and a second deployed position;
providing a second actuator configured to move the second movable member between the second stowed position and the second deployed position; and
in response to satisfaction of a second operating condition, controlling the second actuator, via the controller to move the second movable member from the second stowed position to the first deployed position.

15. The method of claim 14, further comprising, in response to satisfaction of the first operating condition, controlling the second actuator, via the controller, to maintain the second movable member in the second stowed position, and, in response to satisfaction of the second operating condition, controlling the first actuator, via the controller, to maintain the first movable member in the first stowed position.

16. The method of claim 14, further comprising, in response to a braking request exceeding a threshold, controlling the first actuator, via the controller, to move the first movable member from the first stowed position to the first deployed position and controlling the second actuator, via the controller, to move the second movable member from the second stowed position to the first deployed position.
